(19) United States
(12) Patent Application Publication
(10) Pub. No.: US 2015/0200476 A1
(43) Pub. Date: Jul. 16, 2015

(54) ELECTRICAL CONNECTOR

(71) Applicant: FOXCONN INTERCONNECT TECHNOLOGY LIMITED, Grand Cayman (KY)

(72) Inventor: FANG-JWU LIAO, New Taipei (TW)

(21) Appl. No.: 14/597,238

(22) Filed: Jan. 15, 2015

(30) Foreign Application Priority Data
Jan. 15, 2014 (TW) 103200793

(51) Int. Cl. H01R 12/70

(52) U.S. Cl. CPC H01R 12/7076; H01R 12/7082

(57) ABSTRACT

An electrical connector, adapted for electrically connecting an IC package and a printed circuit board, comprises an insulative housing and a plurality of contacts. The insulative housing has a plurality of contact holes therethrough and two positioning holes. The insulative housing has a first region and a second region, correspondingly the contact holes include first holes arranged in the first region and second holes arranged in the second region. Each positioning hole defines an axis, and a line is connecting the axes of the positioning holes. The conductive contacts are received in the first and the second contact holes, and each conductive contact has an upper elastic arm, the upper elastic arms of the conductive contacts in the first contact holes are symmetrical to that in the second contact holes with respective to the line.

### BACKGROUND OF THE INVENTION

1. Field of the Invention

The present invention relates to electrical connectors, more particularly to an electrical connector for electrically connecting a CPU with a printed circuit board.

2. Description of Related Art

U.S. Pat. No. 7,625,217 discloses an esocket, adapted for electrically connecting an IC package with a printed circuit board, comprises an insulative housing and a plurality of contacts received in the insulative housing, the insulative housing defines a loading face, a mounting face opposite to the loading face and a plurality of slots passing through the loading face and the mounting face, the contacts are received in the slots. The contact has an elastic arm extending beyond the loading face of the insulative housing. The insulative housing defines a first area and a second area, the slots are arranged in the first and the second areas. The first area has a first positioning hole, the second area has a second positioning hole, and the first positioning hole and the second positioning hole are diagonally set. The elastic arms in first area extend toward the first positioning hole and the elastic arms in second area extend toward the second positioning hole. Since the first and the second positioning holes are diagonally set, a linking line of the first and the second positioning holes has an angle with the elastic arm, when put the IC package to the socket or put the socket to the printed circuit board, the positioning holes are forced unbalancedly, and may destroy the insulative housing.

Hence, an improved electrical connector is desired to overcome the above problems.

### BRIEF SUMMARY OF THE INVENTION

According to one aspect of the present invention, an electrical connector, adapted for electrically connecting an IC package and a circuit board, comprises an insulative housing a plurality of conductive contacts. The insulative housing defines a top face and a bottom face, a plurality of contact holes through the top and the bottom faces and two opposite positioning holes. The insulative housing has a first region and a second region disposed opposite to the first region. The contact holes have a plurality of first contact holes in the first region and a plurality of second contact holes in the second region. Each positioning hole defines an axis, a line connecting the axes of the positioning holes is located between the first region and the second region. The conductive contacts are received in first and the second contact holes and each has an upper elastic arm extending toward the line, the upper elastic arms of the conductive contacts in the first contact holes are symmetrical to that in the second contact holes with respective to the line.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an electrical connector according to the present invention;

FIG. 2 is another assembled, perspective view of the electrical connector in FIG. 1;

FIG. 3 is a top view of the electrical connector according to the present invention;

FIG. 4 is an exploded, perspective view of the electrical connector according to the present invention;

FIG. 5 is another view of the electrical connector in FIG. 4; and

FIG. 6 is a perspective view of contacts in the electrical connector.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

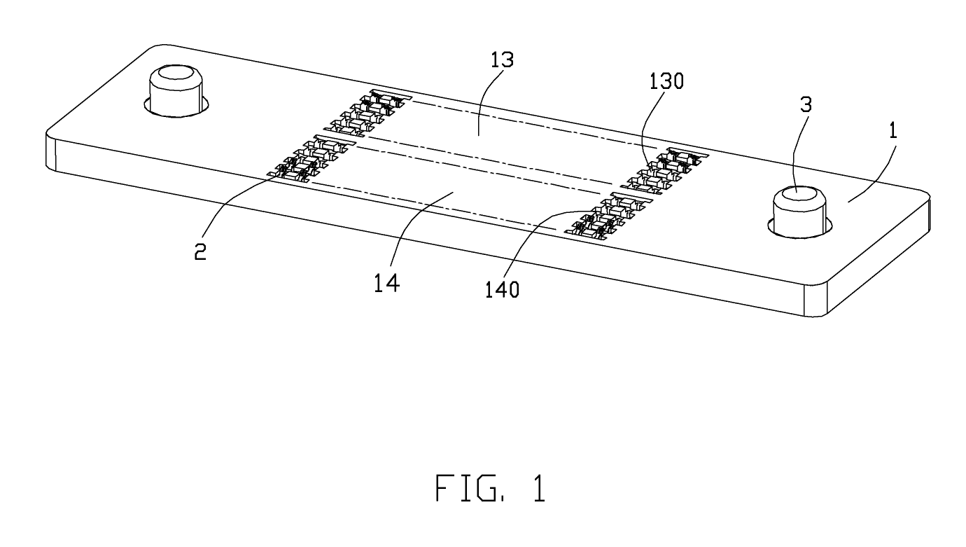

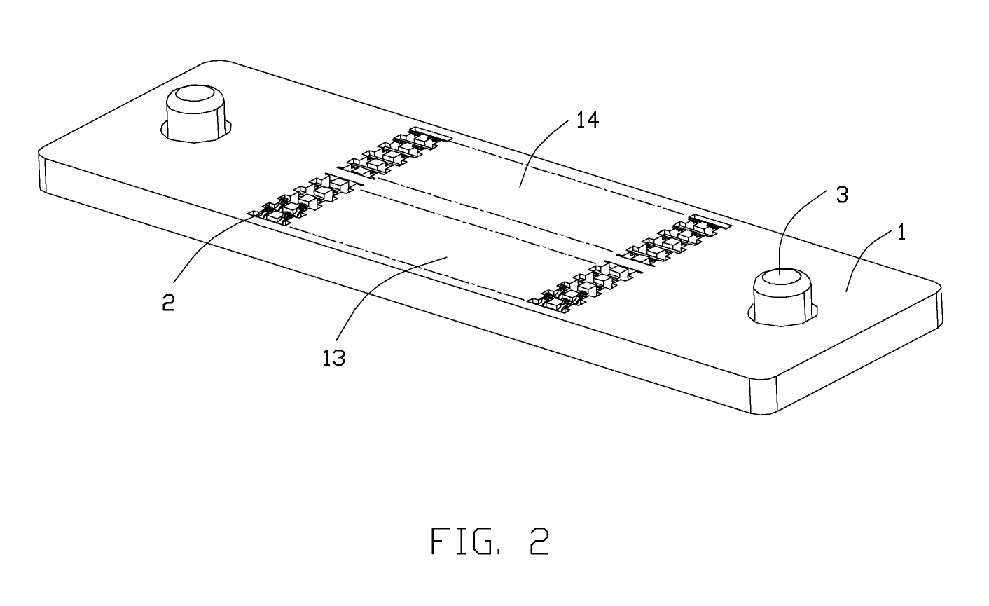

Referring to FIGS. 1-3, the connector assembly comprises an electrical connector electrically connecting an IC package and a circuit board (not shown) and two positioning posts 3 positioning the electrical connector, the electrical connector comprises an insulative housing 1 and a plurality of conductive contacts 2.

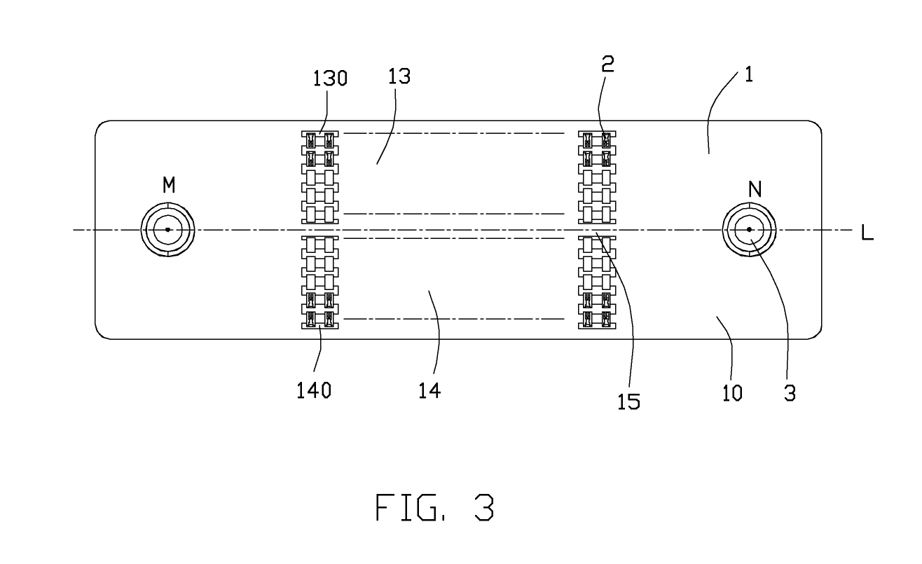

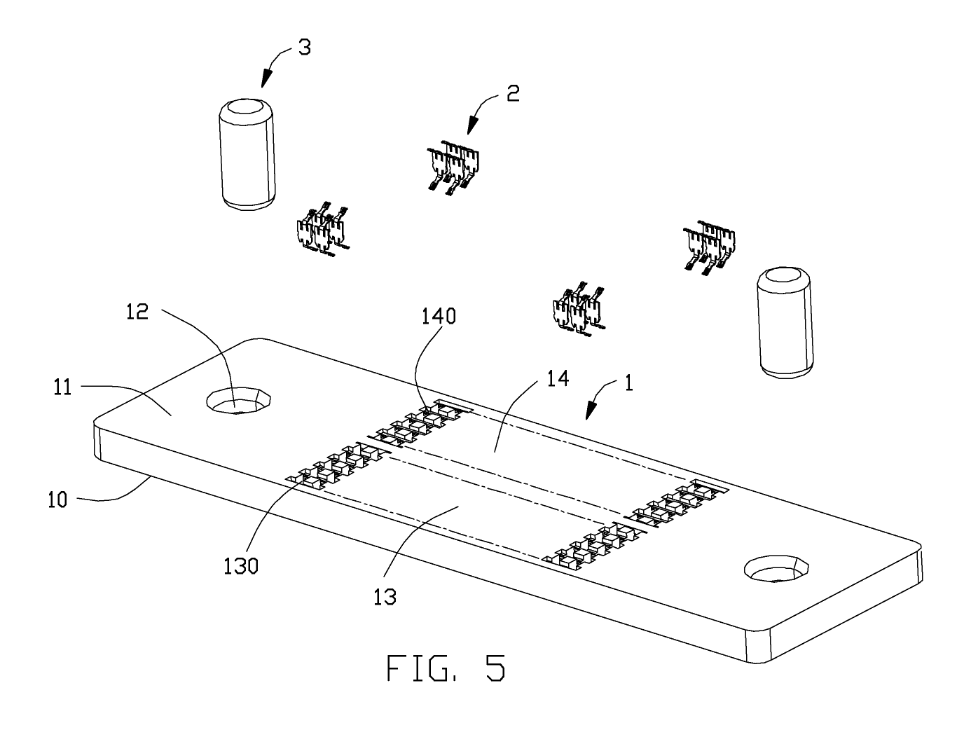

Referring to FIGS. 3-5, the insulative housing 1 has a plane shape, with a top surface 10 and a bottom surface 11 opposite to the top surface, a plurality of contact holes passing though the top surface 10 and the bottom surface 11, and two positioning holes 12 also through the top surface 10 and the bottom surface 11.

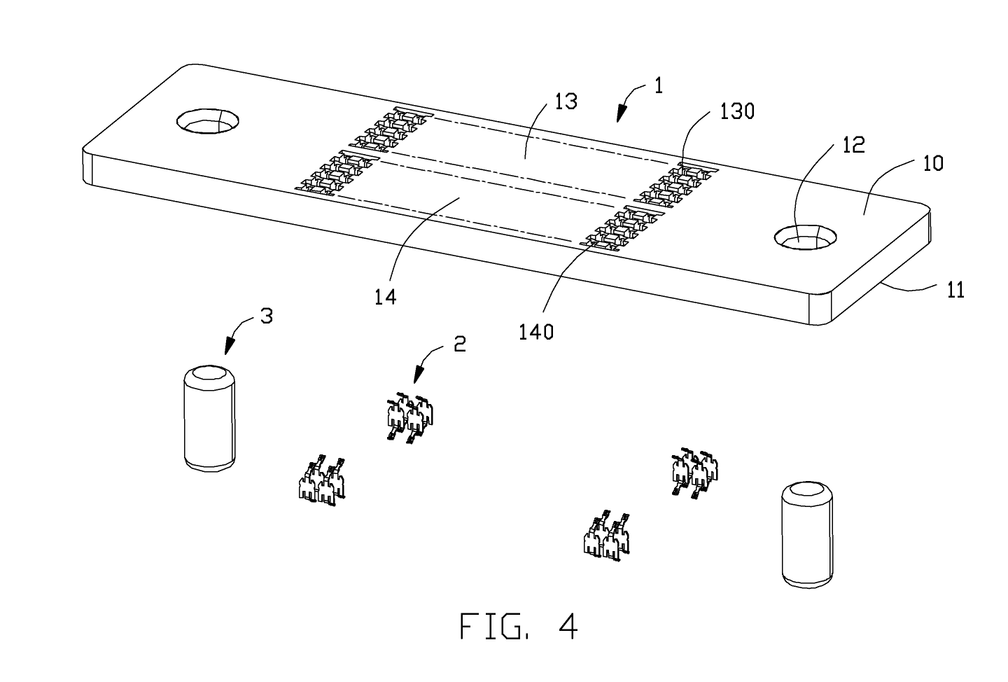

The insulative housing 1 has a first region 13 and a second region 14 symmetrical to first region 13. The contact holes comprises a plurality of first contact holes 130 arranged in the first region 13 and a plurality of second contact holes 140 arranged in the second region 14. There is a fence 15 between the first contact hole 130 and the second contact hole 140. Each of the positioning holes 12 has an axis M/N, and a beeline connecting the axes M, N defines a central line L in the fence 15, the first contact holes 13 in the first region 13 and the second contact holes 14 in the second region 14 are symmetrical relative to the central line L. The central line L is located in a boundary of the first region 13 and the second region 14. In present embodiment, the insulative housing 1 is a rectangular shape, the positioning holes 12 are defined on a center of the right and the left edge thereof, the first region 13 occupies a front part of the insulative housing 1, and the second region 14 occupies a rear part of the insulative housing 1 as shown in FIG. 4. The two positioning posts 3 are received in the two positioning holes 12 of the insulative housing 1 and are separated disposed with the conductive contact 2, so as to position the electrical connector. The positioning post 3 has a height higher than a thickness of the insulative housing 1.

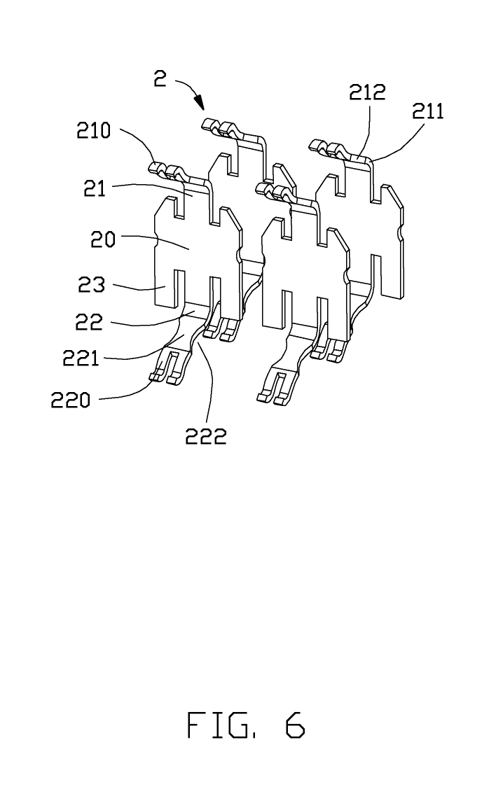

Referring to FIG. 6, the conductive contact 2 has a main body 20, an upper elastic arm 21 extending from the main body 20, a lower elastic arm 22 extending downwardly from the main body 20 and two retention portion 23 extending outwardly from two lateral sides of the main body 20. The upper elastic arm 21 has an upper connecting portion 211 connecting with the main body 20 and an upper contacting portion 210 connecting with the upper connecting portion 211 so as to electrically with the IC package. The lower elastic arm 22 has a lower connecting portion 221 connecting with the main body 20 and a lower contacting portion 220 connecting with the lower connecting portion 221 so as to electrically with the circuit board.

The upper connecting portion 211 has an arch cutting portion 212 on each of two sides thereof to reduce a stress of the conductive contact 2, and the lower connecting portion 221 has another arch cutting portion 222 on two sides thereof to reduce a stress of the conductive contact 2. The upper elastic arm 21 has a same extending direction as that of the lower elastic arm 22 for a same conductive contact 2. And the upper and lower elastic arms 21, 22 of the conductive contact 2 in the first region 13 have an opposite extending direction to the upper and lower elastic arms 21, 22 of the conductive contact 2 in the second region 14, respectively.

At least one of the upper elastic arms 21 and the lower elastic arms 22 of the conductive contacts 2 are symmetrical installed relative to the line through the axes, in other word, the upper elastic arms 21 and/or the lower elastic arms 22 are/is symmetrical relative to the central line L. The elastic arms 21 and the elastic arms 22 all extending toward the central line 1. An extending direction of the upper elastic arm 21 is vertical to the central line L.

Simply say, a first part of the electrical connector comprising the first region 13 and the conductive contacts 2 installed in the first region 13 and a second part of the electrical connector comprising the second region 14 and the conductive contacts 2 installed in the second region 14 are symmetrical disposed with respective to the central line L, which also connects the axes M, N of the two positioning holes 12. For the conductive contacts 2 in the first contact hole 130 and the second contact hole 140 are symmetrical disposed, so two conductive contacts 2 which are symmetrical in the first and the second region 13, 14 respectively, have an same force moment to the positioning holes 12, so the forces caused by the two conductive contacts 2 in the first and the second region 13, 14 are quits, and will not induce stress concentrations to the positioning holes 12 which may destroy the insulative housing 1.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical connector, adapted for electrically connecting an IC package and a circuit board, comprising:
an insulative housing, the insulative housing defining a top face and a bottom face, a plurality of contact holes through the top and the bottom faces and two opposite positioning holes, the insulative housing having a first region and a second region disposed opposite to the first region, the contact holes having a plurality of first contact holes in the first region and a plurality of second contact holes in the second region, each positioning hole defining an axis, a line connecting the axes of the positioning holes being located between the first region and the second region; and
a plurality of conductive contacts, the conductive contacts received in first and the second contact holes and each having an upper elastic arm extending toward the line, the upper elastic arms of the conductive contacts in the first contact holes being symmetrical to those in the second contact holes with respect to the line.

2. The electrical connector as claimed in claim 1, wherein the conductive contact has a main body, the upper elastic arm extending from the main body, a lower elastic arm extending downwardly from the main body and two retention portion extending outwardly from two lateral sides of the main body.

3. The electrical connector as claimed in claim 2, wherein the upper elastic arm has a same extending direction as that of the lower elastic arm for a same conductive contact.

4. The electrical connector as claimed in claim 2, wherein the upper elastic arm has an upper connecting portion connecting with the main body and an upper contacting portion connecting with the upper connecting portion, the lower elastic arm has a lower connecting portion connecting with the main body and a lower contacting portion so as to electrically with the circuit board.

5. The electrical connector as claimed in claim 4, wherein the upper connecting portion has an arch cutting portion on each of two sides thereof to reduce a stress of the conductive contact.

6. The electrical connector as claimed in claim 3, wherein the first region and a second region are symmetrical with respective to the line.

7. The electrical connector as claimed in claim 2, wherein an extending direction of the upper elastic arm is vertical to the line.

8. An electrical connector, adapted for electrically connecting an IC package and a circuit board, comprising:
an insulative housing, the insulative housing having a plurality of contact holes and two positioning holes, the contact holes defined on two regions of the insulative housing which are symmetrical to a line, the positioning holes disposed on two opposite edges or corners thereof respectively, and a line connecting axes of the positioning holes superposing the line; and
a plurality of conductive contacts received in contact holes, each of the conductive contact having an upper elastic arm, the upper elastic arms of the conductive contacts being symmetrical disposed in the contacts with respect to the line.

9. The electrical connector as claimed in claim 8, wherein the conductive contact has a main body, the upper elastic arm extending from the main body, a lower elastic arm extending downwardly from the main body and two retention portion on two lateral sides of the main body.

10. The electrical connector as claimed in claim 9, wherein the upper elastic arm has a same extending direction as that of the lower elastic arm for a same conductive contact.

11. The electrical connector as claimed in claim 10, wherein the upper connecting portion has an arch cutting portion on each of two sides thereof to reduce a stress of the conductive contact.

12. The electrical connector as claimed in claim 10, wherein an extending direction of the upper elastic arm is vertical to the line.

13. The electrical connector as claimed in claim 2, wherein the positioning holes are defined on a center of a right and a left edge of the insulative housing, and the two regions are a front part and a rear part of the insulative housing.

14. An electrical connector comprising:
an insulative planar housing defining opposite top and bottom surfaces in a vertical direction;
a pair of positioning holes spaced from each other in a transverse direction perpendicular to said vertical direction, and defining a first imaginary line linked between two centers of said pair of positioning holes, respectively;
opposite first and second regions formed by two sides of said line;
a plurality of first contacts retained to the housing and located in the first region in matrix, each of said first contacts including a first top spring arm extending, in a top view, toward the line in a first lengthwise direction which is perpendicular to both said vertical direction and said transverse direction; and
a plurality of second contacts retained to the housing and located in the second region in matrix, each of said second contacts including a second top spring arm extending, in the top view, toward the line in a second lengthwise direction opposite to said first lengthwise direction and perpendicular to both said vertical direction and said transverse direction; wherein
said first top spring arms and said second top spring arms are arranged with pairs, and in each pair the corresponding first top spring arm and second top spring arm are symmetrically arranged with each other with regard to the line.

15. The electrical connector as claimed in claim 14, wherein each of said first contacts further includes a first bottom spring arm symmetrically arranged and aligned with the corresponding first top spring arm in said vertical direction, and each of said second contacts further includes a second bottom spring arm symmetrically arranged and aligned with the corresponding second top spring arm in said vertical direction.

16. The electrical connector as claimed in claim 15, wherein the first top spring arms and the second top spring arms extend above the upper surface of the housing, and the first bottom sprint arms and the second bottom spring arms extend below the bottom surface of the housing.

17. The electrical connector as claimed in claim 14, wherein in each pair, the first contact and the second contact are identical while being wholly symmetrical arranged with each other with regard to the line.

18. The electrical connector as claimed in claim 14, wherein each of said first contacts includes a vertical retaining section with barbs thereon, and the corresponding first top spring arm and the first bottom spring arm extend from opposite top and bottom edges of said vertical retaining section, respectively.

19. The electrical connector as claimed in claim 14, wherein the first top spring arm of each of said first contacts forms a pair of curved notches in two opposite side edges.
